(19) United States
(12) Patent Application Publication
(10) Pub. No.: US 2024/0039076 A1
(43) Pub. Date: Feb. 1, 2024

(54) BATTERY PACK

(71) Applicant: Reliefed AB, Varberg (SE)

(72) Inventor: Mark Kragh, Varberg (SE)

(21) Appl. No.: 18/037,627

(22) PCT Filed: Oct. 12, 2021
(86) PCT No.: PCT/EP2021/078188

§ 371 Date: May 18, 2023

(30) Foreign Application Priority Data
Nov. 30, 2020 (SE) 2051391-7

(51) Int. Cl. H01M 10/653; H01M 50/213; H01M 50/262; H01M 10/656; H01M 10/48; H01M 50/249; B60K 1/04

(52) U.S. Cl. CPC H01M 10/653; H01M 50/213; H01M 50/262; H01M 10/656; H01M 10/486; H01M 50/249; B60K 1/04; H01M 2220/20

(57) ABSTRACT

A battery arrangement (1) comprising a number of batteries (2), arranged next to each other forming a battery pack (6a) with a top surface (7) and an opposing bottom surface (8), wherein the battery arrangement (1) comprises at least one thermal structural element (9) arranged against a top surface (7) and/or a bottom surface (8) of the battery pack (6a) for cooling or heating the batteries (2) via a top end plate (3) and/or a bottom end plate (4) of the batteries via a first through channel (10) in the thermal structural element (9) being configured to lead a thermal fluid medium through the thermal structural element (9), wherein the battery arrangement (1) comprises a fixation element (36; 15, 30, 37) configured to fixate the position of each battery (2) with relation to the thermal structural element (9).

### TECHNICAL FIELD

The invention relates to a battery arrangement comprising a number of batteries, each battery having a top end plate and a bottom end plate opposite the top end plate and a body connecting the top end plate and the bottom end plate, the body having an extension in a longitudinal direction between the top end plate and the bottom end plate and in a thickness direction being perpendicular to the longitudinal direction, wherein the body is delimited in the thickness direction by an envelope surface, wherein the batteries are arranged next to each other in the thickness direction forming a battery pack (6a) with a top surface and an opposing bottom surface in the longitudinal direction, wherein the top surface and the bottom surface have an extension in a width direction and a length direction being perpendicular to the longitudinal direction.

### BACKGROUND ART

Batteries are well known and are used in various applications. Battery driven devices are becoming more important by the day due to environmental concerns. For example, battery driven vehicles are increasing in numbers and with that comes a desire for batteries that are easy and fast to recharge. Recharging a battery puts demand on a number of factors. One important factor for fast recharging is temperature of the battery during charging. Some batteries need to be cooled to a suitable temperature, but some batteries need to be heated, at least initially, to a suitable temperature.

Furthermore, energy consumption is dependent on, for example, weight and the more weight the higher the energy consumption.

### SUMMARY OF INVENTION

With respect to prior art, there is a need for a battery that has improved battery charging and at the same time is lightweight and strong. The invention meets a demand of faster battery charging capabilities and more efficient thermal management, at the same time as it is lighter and structurally strong and rational to produce with few parts and/or materials to assemble in production, and also rational to disassemble at end of life for recycling or reuse of cells. The invention is a lightweight, structurally strong battery with very few parts, integrating cooling into the structure enabling fully charging in as little as 5-6 minutes without any risk overheating the cells. The main parts, i.e. a thermal structural element, utilise extruded profiles that function as structure, battery fixation and battery cooling with cooling channels for cooling fluid/gas integrated and the profiles are thermally connected to the ends of the batteries, utilising the battery cells ability to efficiently transfer heat “in-plane”, i.e. from the top end or bottom end of the batteries. Furthermore, the possibility of using the extruded profiles for fixation of the battery cells eliminates need of separate parts and material for fixating the batteries and thus reduce the amount of components and material in the battery pack, resulting in further savings of material, weight and cost, also resulting in quick assembly and disassembly.

The invention relates to a battery arrangement comprising a number of batteries, each battery having a top end plate and a bottom end plate opposite the top end plate and a body connecting the top end plate and the bottom end plate, the body having an extension in a longitudinal direction between the top end plate and the bottom end plate and in a thickness direction being perpendicular to the longitudinal direction, wherein the body is delimited in the thickness direction by an envelope surface, wherein the batteries are arranged next to each other in the thickness direction forming a battery pack with a top surface and an opposing bottom surface in the longitudinal direction, wherein the top surface and the bottom surface have an extension in a width direction and a length direction being perpendicular to the longitudinal direction, wherein the battery arrangement comprises at least one thermal structural element arranged against the top surface and/or the bottom surface for cooling or heating the batteries via the top end plate and/or the bottom end plate, wherein the thermal structural element has an extension in the width direction and the length direction and a height coinciding with the longitudinal direction, wherein the thermal structural element comprises a first through channel extending along the top surface and/or the bottom surface, wherein the first through channel extends from one side portion of the thermal structural element to an opposite side portion of the thermal structural element, the through channel being configured to lead a thermal fluid medium through the thermal structural element, wherein the battery arrangement comprises a fixation element configured to fixate the position of each battery with relation to the thermal structural element.

One advantage is that the thermal structural element has a combined ability to fixate the batteries in position and at the same time regulate temperature of the batteries by either cooling or heating the batteries via at least one of the end plates. The temperature of the batteries is important at least during charging of the batteries and with this arrangement it is possible to charge the batteries at a high energy level and thus charge during a very short time period by controlling the battery temperature in dependence of the environment. For example, in a hot climate it is important to cool the batteries during charging to an optimum temperature dependent on type of batteries, and in a cold climate the batteries may need to be heated before starting charging the batteries. The thermal structural element is arranged in one piece and in a material that allows for high heat transfer from the batteries to the thermal fluid medium in the through channel during cooling and for high heat transfer from the thermal fluid media to the batteries during heating of the batteries. The incorporated through channel allows for transporting the thermal fluid medium to and from the thermal structural element. The thermal fluid medium can be part of an external circuit, for example a vehicle heat and/or cooling circuit, and the through channel can be connected to such a circuit via any suitable connections and fluid conductors. Should the thermal structural element comprise more than one through channel the through cannels may be interconnected creating one internal heat and/or cooling circuit where the thermal fluid medium is fed into one through channel via an inlet and the outlet of that channel can be connected to the inlet of an adjacent through channel and the outlet of that channel can be connected to a further through channel if there are more than two through channels, and the last outlet is connected to the external circuit. One advantage here is that the thermal structural element gets a more even thermal distribution than if each channel was fed separately. As mentioned above, the through channels can interconnected by any suitable connections and fluid conductors.

According to one example, the thermal structural element comprises a second through channel extending along the top surface and/or the bottom surface, wherein the first through channel and the second through channel extend from one side portion of the thermal structural element to an opposite side portion of the thermal structural element, wherein the first and second through channels in the thermal structural element are interconnected for inlet and outlet of the thermal fluid medium from the same side portion.

The thermal fluid medium can be any suitable gas or liquid that enables transport of heat to or from the batteries.

As will be explained further below, a number of battery packs may be arranged together forming a larger battery assembly. Each battery pack comprises at least one thermal structural element and the through channels in the different the thermal structural elements are interconnected to allow for a thermal fluid medium circuit. The through channels may be interconnected in series, with our without an internal heat and/or cooling circuit, but it is also possible to feed each of the through channels separately. One advantage of separately connecting the thermal structural element to the external circuit is that each thermal structural element can be thermally adjusted. For example, it could be that a battery pack in the middle of the battery arrangement has a different need that a battery pack positioned on the edges of the battery arrangement.

According to one example, the thermal structural element comprises structural features configured to withstand a predetermined force in at least the width direction and/or the length direction.

One advantage her is that the thermal structural element gets a further combined ability together with the fixation of the batteries and the thermal management. The structural features strengthen the thermal structural element such that the battery pack and the battery arrangement becomes strong and can resist external forces that otherwise could harm the batteries if the thermal structural element would give away under pressure. A further advantage with the structural features is that the thermal structural element can be made light weight since material can be removed from an otherwise evenly thick plate.

The combination of a straight through channel extending from one end to another, the fixation element being part of the thermal structural element and the structural features, gives the possibility to manufacture the thermal structural element as an extruded profile product comprising a surface pattern, i.e. the structural features and the fixation elements, made from a rotating die in the extrusion process.

According to one example, the thermal structural element comprises an underside facing the batteries and a topside facing away from the batteries, wherein the underside comprises the fixation elements configured to receive the top end plate and/or the bottom end plate. Here, the topside comprises the structural features.

According to one example, the structural features comprises an isometric grid. One advantage here is that the isomeric grid gives an optimum weight to strength ratio. Other types of patterns of the structural features are also possible and depends on the type application for which the battery arrangement is used.

According to one example, the battery arrangement comprises at least two battery packs stacked in the height direction, wherein the battery arrangement comprises an interconnecting thermal structural element with one side facing the batteries in one of the battery packs and a second side facing the batteries in the second battery pack, wherein both sides of the interconnecting thermal structural element have similar features as the side of the thermal structural elements that faces the batteries.

According to one example, the fixation element comprises an indentation and/or a middle layer and/or protrusions extending from the thermal structural element configured to secure the position of the battery.

According to one example, the battery arrangement comprises a middle layer between the thermal structural element and the top surface and/or the bottom surface.

According to one example, the middle layer is arranged essentially over the entire top end plate and/or the bottom end plate and wherein the middle layer has a lower thermal conductivity than the thermal structural element and therefore acts as a thermal equalizer between the batteries and the thermal structural element.

According to one example, the middle layer comprises fixation elements in the form of attachment means for attaching the batteries to the thermal structural element.

According to one example, the middle layer is resilient allowing for a predetermined relative motion between the batteries and the thermal structural element.

According to one example, the thermal structural element comprises metal wherein the battery arrangement comprises an electrically isolating middle layer between the thermal structural element and the top end plate and the bottom end plate. According to one example, the thermal structural element is made from aluminium or an aluminium alloy.

According to one example, the thermal structural element is made from an electrically non-conductive material, wherein the thermal structural element is arranged directly against the top end plate and the bottom end plate or wherein the thermal structural element is made from an electrically non-conductive material, wherein the middle layer is arranged between the thermal structural element and the top end plate and the bottom end plate. One example of a suitable non-conductive material for the thermal structural element is ceramics since such a material is also fire proof. Other materials are also possible, for example plastic or a plastic composite or a metal-plastic composite or a ceramic or from a ceramic matrix composite.

According to one example, the middle layer is configured as a sheet material and/or a curable liquid.

According to one example, the battery arrangement comprises one thermal structural element arranged against the top surface and one thermal structural element arranged against the bottom surface for cooling or heating the batteries via the top end plate and/or the bottom end plate. One advantage here is improved thermal ability for cooling and/or heating the batteries. A further advantage is that the battery pack and the battery arrangement increases its strength, i.e. possibility to withstand external forces.

According to one example, the battery arrangement comprises at least one side wall attached to the two thermal structural element covering a side portion of the battery pack.

According to one example, the battery arrangement comprises at least two battery packs, wherein the thermal structural element from each battery pack is interconnected for forming an expanded battery arrangement wherein the thermal structural elements comprises connecting means along at least one of the side portions delimiting the thermal structural element in the width direction or the length direction for interconnecting the battery packs.

According to one example, the connecting means comprises sliding and connecting means allowing for interconnecting the thermal structural elements via a sliding operation or wherein the connecting means comprises hooking and connecting means allowing for interconnecting the thermal structural elements via a hooking operation.

According to one example, the thermal structural element comprises grooves and/or indentations for housing connecting cables. The groves and indentations may also be formed by the rotating die in the extruding process.

According to one example, the thermal structural element comprises at least one through opening extending in the height direction for receiving a fastening means extending through the through opening.

According to one example, the arrangement comprises at least one side wall attachable to at least one side portion of the thermal structural element, wherein the side wall has an extension in the longitudinal direction as well as along the side portion.

According to one example, the thermal structural element comprises attachment means along at least one side portion for attachment of the sidewall.

According to one example, the side wall facing the inlet and/or outlet of the through channels comprises fluid conductors for connecting to the through channels. The external thermal circuit may be connected to the battery arrangement via the side walls.

As mention above, the structural features and strength of the battery arrangement makes it especially advantageous as a structural feature being part of an external structure, for example in a vehicle.

The invention therefore relates to a vehicle comprising a battery arrangement according to the above, wherein the battery arrangement is configured as a part of the structural body of a vehicle or any other structural body of an application in which the battery arrangement is a part.

The invention is not limited to the above example, but further features may be added. For example, the structural thermal elements can be made of metal with anodised surface providing thermal and/or electrical insulation between metal in structural thermal elements and the batteries. The thermal structural elements can also be used as current collectors from the batteries on either of or both sides of the plus pole and the minus pole side. Furthermore, the battery arrangement may comprise temperature sensors attached to or in connection to the thermal structural elements for sending information to a control unit controlling the thermal fluid medium through the thermal structural element. The sensor(s) can be any suitable sensor for detecting temperature. The control unit can be any suitable control unit with computing capacity comprising receiving and transmitting means for controlling the external circuit, for example a vehicle heat and/or cooling circuit. The control unit can further comprise a memory for storing data regarding suitable charging temperatures of the batteries, which data is correlated to the temperature input data from the sensor(s) such that the control gives an output control signal to the circuit to either cool or heat the thermal structural element via the thermal fluid medium in the through channel(s) and a suitable feeding rate of the thermal fluid medium dependent on input from the sensors. The control unit for the battery arrangement can be a separate control unit that controls, e.g. the flow rate of, the thermal fluid medium to and from the battery arrangement in dependence on input from the sensors. The flow rate can be controlled by one or more valves that opens and closes and/or one or more pumps with varied pumping effect or the like, dependent on cooling or heating needs. Here, the control unit can be connected to and in communication with a control unit for the external circuit and the valves and/or pumps may be part of the external circuit or there may be a separate circuit for the battery arrangement connected to the external circuit. As an alternative, the control unit is part of the control unit in the external circuit.

### BRIEF DESCRIPTION OF DRAWINGS

The invention will below be described in connection to a number of drawings, in which:

FIG. 1 schematically shows a perspective view of a battery arrangement according to one example;

FIG. 2 schematically shows a perspective view of a thermal structural element according to one example;

FIG. 3 schematically shows a perspective view of two thermal structural elements according to one example;

FIG. 4 schematically shows a perspective view of two battery packs positioned on top of each other in the height direction according to one example;

FIG. 5 schematically shows a perspective view of twelve battery packs packed into one battery unit, wherein three battery packs are positioned on top of each other in the height direction forming one sub unit, wherein two sub units are positioned next to each other in the length direction and four sub units are positioned next to each other in the width direction forming the battery unit according to one example;

FIG. 6 schematically shows a perspective view of nine battery packs packed into one battery unit, wherein three battery packs are positioned on top of each other in the height direction forming one sub unit, wherein three sub units are positioned next to each other in the length direction forming the battery unit according to one example;

FIG. 7 schematically shows a perspective view of fifty-four battery packs packed into one battery unit, wherein three battery packs are positioned on top of each other in the height direction forming one sub unit, wherein two sub units are positioned next to each other in the length direction and twelve sub units are positioned next to each other in the width direction forming the battery unit according to one example;

FIG. 8 schematically shows a perspective view of two battery packs positioned next to each other in the length direction and coupled to each other via a sliding arrangement according to one example;

FIG. 9 schematically shows a side view in the width and height direction of the arrangement in FIG. 8;

FIG. 10 schematically shows a close up of the sliding arrangement in FIGS. 8 and 9 according to one example;

FIG. 11 schematically shows a close up of the sliding arrangement in FIGS. 8 and 9 according to one example

FIG. 12 schematically shows a close up of a side wall arrangement of an upper thermal structural element in FIGS. 8 and 9 according to one example;

FIG. 13 schematically shows a close up of a side wall arrangement of a bottom thermal structural element in FIGS. 8 and 9 according to one example;

FIG. 14 schematically shows a top view of different battery fixing elements;

FIG. 15 schematically shows a side view of FIG. 14;

FIG. 16 schematically shows a similar view as FIG. 8 with four enclosing side walls;

FIG. 17 schematically shows a similar view as FIG. 4 with four enclosing side walls;

FIG. 18 schematically shows a perspective view of a battery arrangement according to one example;

FIG. 19 schematically shows a perspective view of a battery arrangement according to FIG. 18, and wherein;

FIG. 20 schematically shows a perspective view of a vehicle comprising a battery arrangement according to any one of FIGS. 1-17.

### DETAILED DESCRIPTION

The invention will below be described in connection to a number of non-exclusive embodiments. Like features will be denoted with like numbers. In order to facilitate the description of the embodiments a three dimensional Cartesian orthogonal coordinate system has been used where the X-axis is denoted length direction, the Y-axis is denoted width direction and where the Z-axis is denoted height direction.

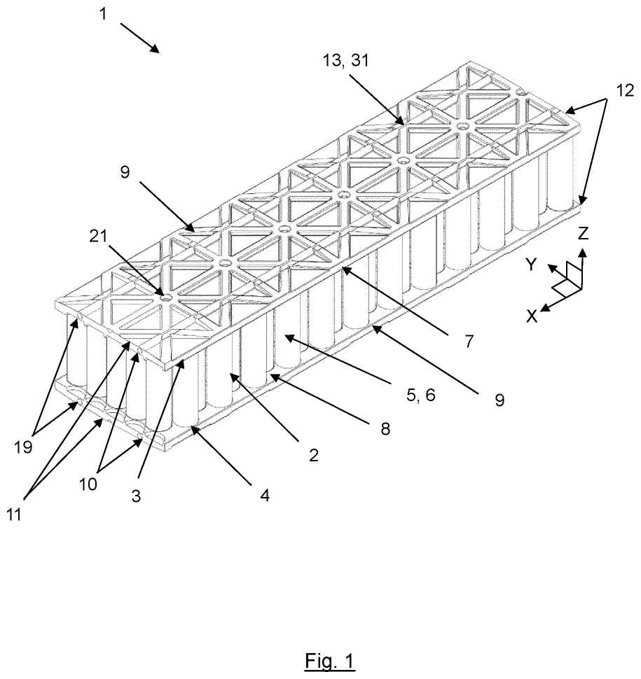

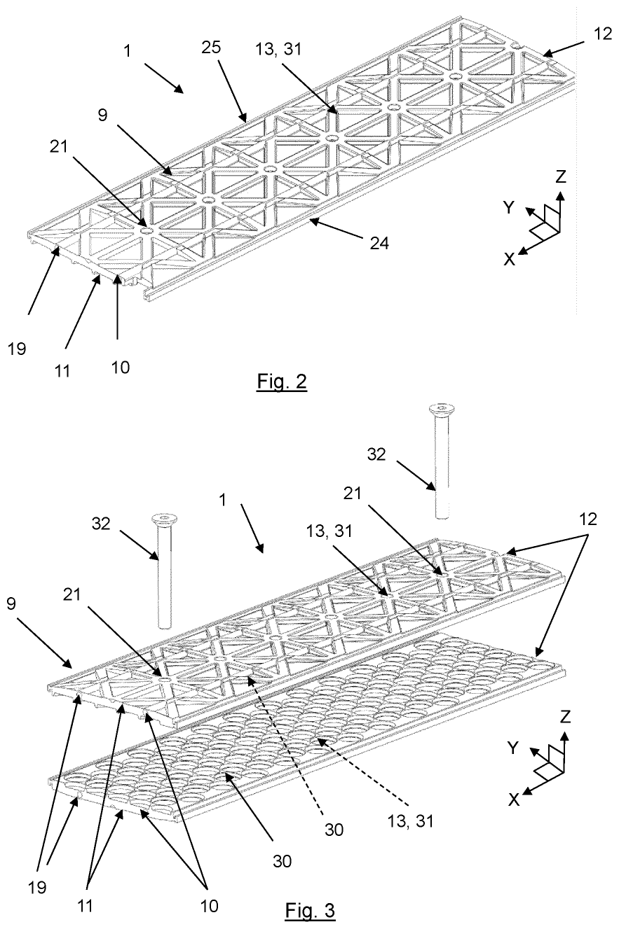

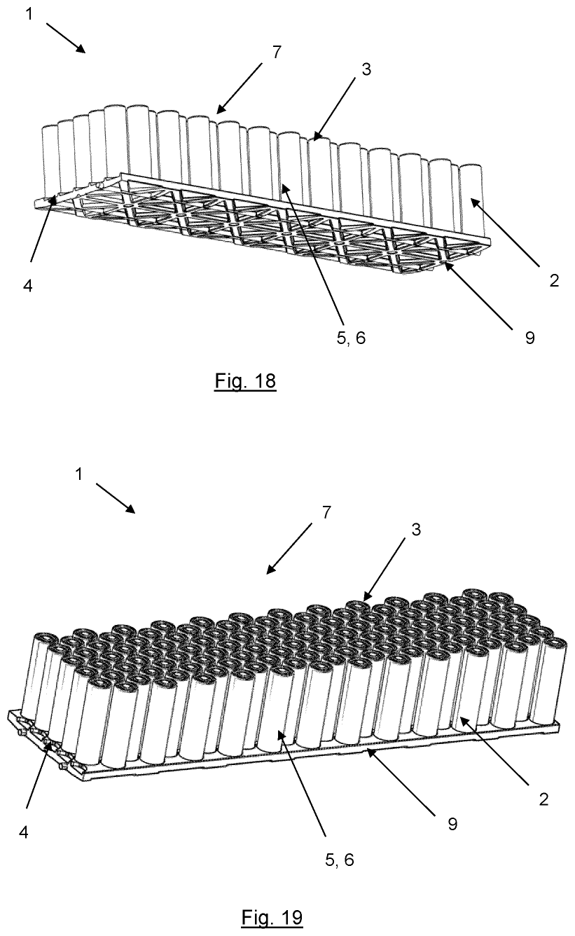

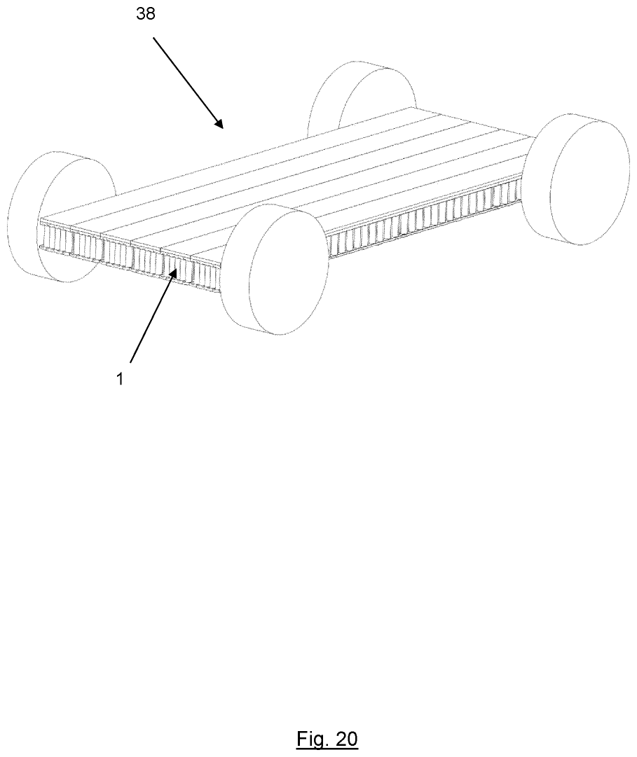

FIG. 1 schematically shows a perspective view of a battery arrangement 1 according to one example with two thermal structural elements 9. FIG. 2 schematically shows a perspective view of a thermal structural element 9 according to one example. FIG. 3 schematically shows a perspective view of two thermal structural elements 9 according to one example. FIGS. 18 and 19 schematically show two perspective views of a battery arrangement according to one example with one thermal structural element 9;

FIGS. 1-3, 18 and 19 schematically shows a battery arrangement 1 comprising a number of batteries 2, each battery 2 having a top end plate 3 and a bottom end plate 4 opposite the top end plate 3 and a body 5 connecting the top end plate 3 and the bottom end plate 4, the body 5 having an extension in the longitudinal direction Z between the top end plate 3 and the bottom end plate 4 and in a thickness direction X, Y being perpendicular to the longitudinal direction, wherein the body 5 is delimited in the thickness direction X, Y by an envelope surface 6, wherein the batteries 2 are arranged next to each other in the thickness direction X, Y forming a battery pack 6a with a top surface 7 and an opposing bottom surface 8 in the longitudinal direction Z, wherein the top surface 7 and the bottom surface 8 have an extension in a width direction Y and a length direction X being perpendicular to the longitudinal direction Z, wherein the battery arrangement 1 comprises at least one thermal structural element 9 arranged against the top surface 7 and/or the bottom surface 8 for cooling or heating the batteries 2 via the top end plate 3 and/or the bottom end plate 4, wherein the thermal structural element 9 has an extension in the width direction Y and the length direction X and a height coinciding with the longitudinal direction Z, wherein the thermal structural element 9 comprises a first through channel 10 extending along the top surface 7 and/or the bottom surface 8, wherein the first through channel 10 extends from one side portion 11 of the thermal structural element 9 to an opposite side portion 12 of the thermal structural element 9, the through channel (10) being configured to lead a thermal fluid medium through the thermal structural element (9), wherein the battery arrangement 1 comprises a fixation element 36; 15, 30, 37 configured to fixate the position of each battery 2 with relation to the thermal structural element 9.

The above reference to thickness direction and longitudinal direction for the batteries are introduced only to facilitate the description of the batteries and their relationship in the battery pack. The battery can have any suitable shape with a general extension in the longitudinal direction and delimited in the thickness direction by the envelope surface. For example, a battery with a circular cross-section has a thickness in a radial direction being perpendicular to the longitudinal direction if described in cylindrical coordinates. Using a Cartesian coordinate system as described above, the longitudinal direction can be the height direction Z and the thickness direction is in the plane described by the width direction Y and the length direction. Hence, regardless of the battery shape, the cross-section describing the thickness direction can in Cartesian coordinates be described by a cross-sectional geometry in the X-Y plane for different positions in the height direction Z. When the batteries are positioned next to each other, the thickness direction coincides with the X-Y plane and the longitudinal direction coincides with the height direction Z.

In FIG. 1, there are five batteries 2 positioned in a row in the width direction Y and there are 24 rows in the length direction X forming the battery pack 6a. In FIG. 1, every second rows is positioned offset the adjacent rows for optimum space utilization within the battery pack 6a. The invention is not limited to number of batteries forming a battery back, but this is a design features dependent on e.g. what type of application the battery arrangement should be used in, size and form of batteries and type of arrangement chosen for the batteries. The invention is further not limited to the offset arrangement described above, but may be arranged dependent on e.g. what type of application the battery arrangement should be used in, size and form of batteries, type of batteries, heat and fire prevention, electrical connections between the batteries, etc. Furthermore, the batteries may be arranged such that all plus poles are arranged on one side and all minus on the other side, or there may be a mix where some batteries are oriented with the plus poles facing one side and some batteries oriented with the minus poles facing the same side. This is a design choice dependent on e.g. electrical wiring. Regardless of battery orientation, the thermal structural element 9 advantageously cools down or heats the batteries 2 via the top end plate 3 and/or the bottom end plate 4.

As can be seen from FIGS. 1-18, the battery packs 6a can be arranged in different ways dependent on application need, e.g. energy consumption, battery pack space and position in application.

According to one example, see e.g. FIG. 2, the battery pack 6a comprises one thermal structural element 9 positioned on either the top surface 7 or the bottom surface 8. The surface 7, 8 not being covered with the thermal structural element 9 may form part of a different structure securing the batteries in position on that end. The different structure can be any type of arrangement for housing a battery.

According to one example, see e.g. FIG. 1, the battery pack 6a comprises two thermal structural elements 9 positioned on the top surface 7 and the bottom surface 8. The thermal structural element 9 advantageously cools down or heats the batteries 2 via the top end plate 3 and the bottom end plate 4. As can be seen from FIG. 3, the two thermal structural elements 9 can be secured to each other via a fastening means 32. In this example, the thermal structural elements 9 comprises at least one through opening 21 extending in the height direction Z for receiving a fastening means 32 extending through the through opening 21. The fastening means 32 can be any suitable device or structure for securing the plates together, for example a bolt with or without a nut or a rivet.

FIGS. 1-18 schematically shows that the thermal structural element 9 comprises structural features 13 configured to withstand a predetermined force in at least the width direction Y and/or the length direction X. The structural features 13 are an integral part of the thermal structural element 9. The thermal structural element 9 can according to one example be a homogeneous material where the structural features 13 are configured on one side of the thermal structural element 9. One advantage here is that the thermal structural element 9 becomes lighter due to the removal or lack of material between the structural features 13.

The thermal structural element 9 can according to another example be a homogeneous material where the structural features 13 are embedded within the thermal structural element 9 on one side of the thermal structural element 9. One advantage here is that the thermal structural element 9 becomes lighter due to the removal or lack of material between the structural features 13.

According to one example, the thermal structural element 9 comprises an underside 28 facing the batteries 2 and a topside 29 facing away from the batteries 2, wherein the underside 28 comprises the fixation elements 36 configured to receive the top end plate 3 and/or the bottom end plate 4.

According to one example, the topside 29 comprises the structural features 13.

According to one example, the structural features 13 comprises an isometric grid 31.

The thermal structural element 9 is advantageously an extruded profile product comprising a surface pattern made from a rotating die in the extrusion process.

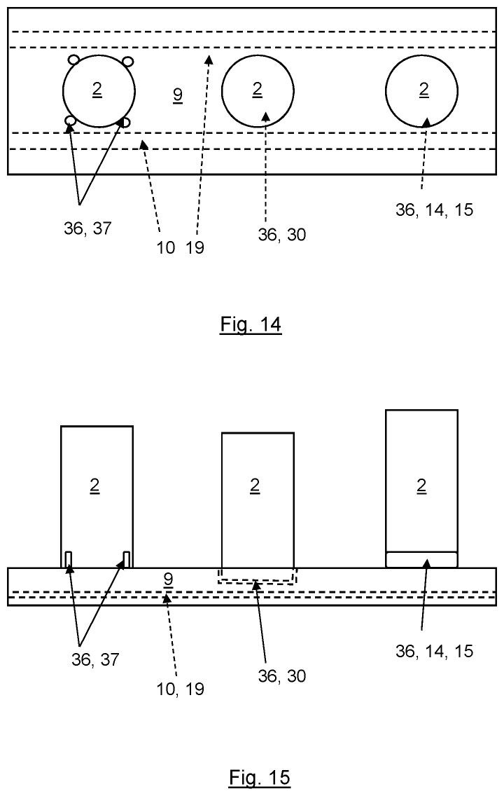

FIGS. 14 and 15 show that the fixation element 36 comprises an indentation 30 and/or a middle layer 14 and/or protrusions 37 extending from the thermal structural element 9 configured to secure the position of the battery 2.

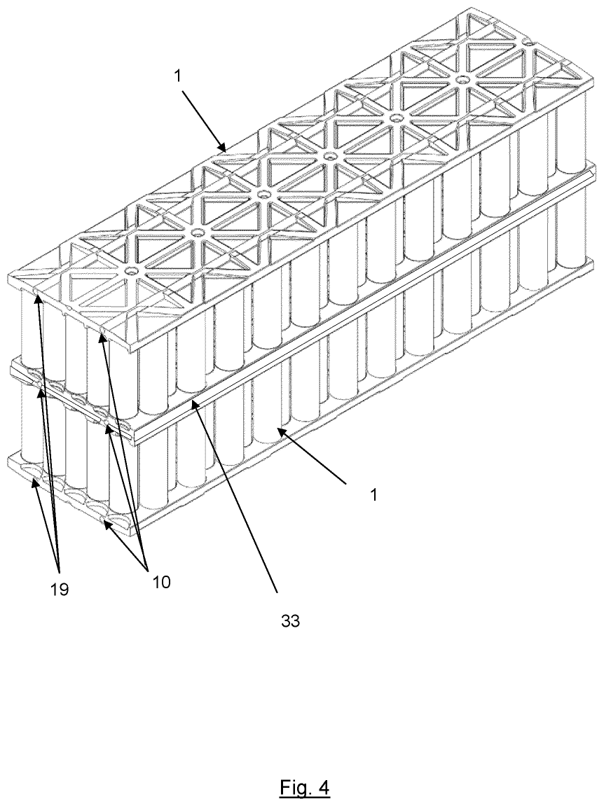

According to one example, see e.g. FIGS. 4, 5, 6, 7 and 17, the battery arrangement 1 comprises at least two battery packs 6a stacked in the height direction Z, wherein the battery arrangement 1 comprises an interconnecting thermal structural element 33 with one side facing the batteries in one of the battery packs 6a and a second side facing the batteries in the second battery pack 6a, wherein both sides of the interconnecting thermal structural element 33 have similar features as the side of the thermal structural elements 9 that faces the batteries 2. In this example, the underside 28 and the topside 29 comprises fixation elements 36 receive the top end plate 3 and/or the bottom end plate 4. In FIGS. 4, 5, 6, 7 and 17 the fixation elements are in the form of indentations 30 configured to receive the top end plate 3 and/or the bottom end plate 4, but other forms of fixation elements 36 are possible. For example, FIGS. 14 and 15 show that the fixation element 36 comprises an indentation 30 and/or a middle layer 14 and/or protrusions 37 extending from the thermal structural element 9 configured to secure the position of the battery 2.

According to one example, the battery arrangement 1 comprises a middle layer 14 between the thermal structural element 9 and the top surface 7 and/or the bottom surface 8.

According to one example, shown in FIG. 13, the middle layer 14 is arranged essentially over the entire top end plate 3 and/or the bottom end plate 4 and wherein the middle layer 14 has a lower thermal conductivity than the thermal structural element 9 and therefore acts as a thermal equalizer between the batteries 2 and the thermal structural element 9. According to one example, the middle layer 14 comprises fixation elements 36 in the form of attachment means 15 for attaching the batteries 2 to the thermal structural element 9. Although, FIG. 13 schematically shows that the fixation elements 36 are in the form of an indentation 30 and a middle layer 14, there is a possibility to configure the underside 28 with a fixation element 36 being only a middle layer 14.

According to one example, the middle layer 14 is resilient allowing for a predetermined relative motion between the batteries 2 and the thermal structural element 9.

According to one example, the thermal structural element 9 comprises metal and wherein the battery arrangement 1 comprises an electrically isolating middle layer 14 between the thermal structural element 9 and the top end plate 3 and the bottom end plate 4. According to one example, the thermal structural element 9 is made from aluminium or an aluminium alloy or any other electrically conductive material.

According to one example, the thermal structural element 9 is made from an electrically non-conductive material, wherein the thermal structural element 9 is arranged directly against the top end plate 3 and the bottom end plate 4 or wherein the thermal structural element 9 is made from an electrically non-conductive material, wherein the middle layer 14 is arranged between the thermal structural element 9 and the top end plate 3 and the bottom end plate 4. The electrically non-conductive material in the thermal structural element 9 can be made from a plastic or a plastic composite or a metal-plastic composite or a ceramic or from a ceramic matrix composite

According to one example, the middle layer 14 is configured as a sheet material and/or a curable liquid. Here, sheet material refers to a material that has a generally flat shape similar to a paper or a board or the like. A curable liquid can be any suitable fluid that can be applied as a middle layer and that cures in such a way that it after curing retains its shape.

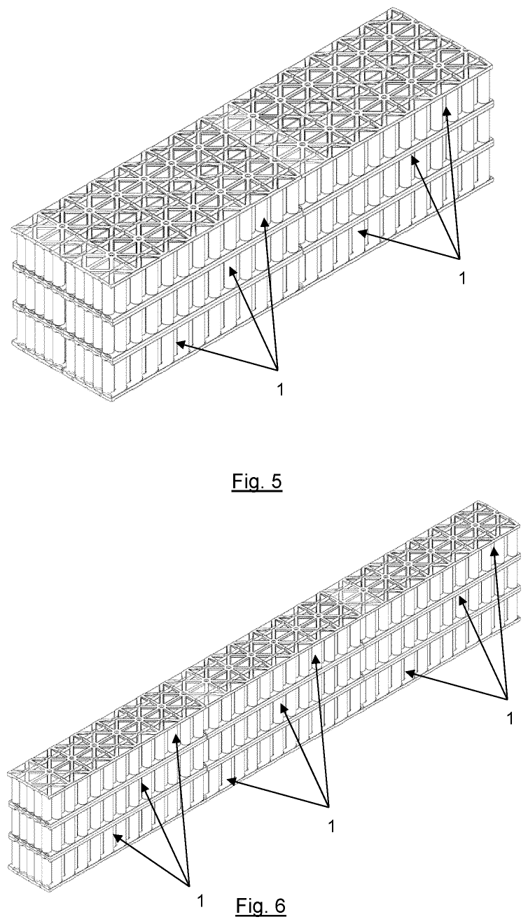

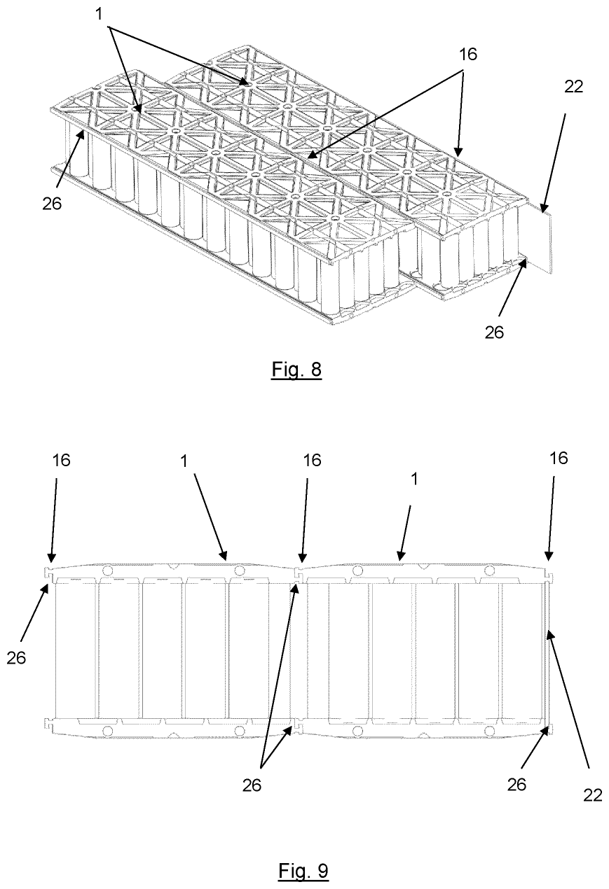

According to one example, the battery arrangement 1 comprises at least one side wall 22, 23 attached to the two thermal structural elements 9 covering a side portion 11, 12, 24, 25 of the battery pack 6a. The side wall 22, 23 can be applied on one side, two sides, three sides or all four sides of the battery pack. As an alternative, the side wall 22, 23 can be applied on one side, two sides, three sides or all four sides of a stacked battery pack 6a. A stacked battery pack 6a can be achieved by stacking batteries on top of each other, as seen in e.g. FIG. 4, 5, 6, 7, or can be achieved by attaching batteries next to each other, as seen in FIG. 8, or a combination of the both as seen in FIG. 5.

According to one example, see e.g. FIG. 8, the battery arrangement 1 comprises at least two battery packs 6a, wherein the thermal structural elements 9 from each battery pack 6a is interconnected for forming an expanded battery arrangement 1 where the interconnected thermal structural element 9 is configured to withstand a predetermined force in at least the width direction wherein the thermal structural elements 9 comprises connecting means 16 along at least one of the side portions 11, 12, 24, 25 delimiting the thermal structural element 9 in the width direction or the length direction for interconnecting the battery packs 6a.

According to one example, see e.g. FIGS. 8-11, the connecting means 16 comprises sliding and connecting means 17 allowing for interconnecting the thermal structural elements 9 via a sliding operation or wherein the connecting means 16 comprises hooking and connecting means 18 allowing for interconnecting the thermal structural elements 9 via a hooking operation.

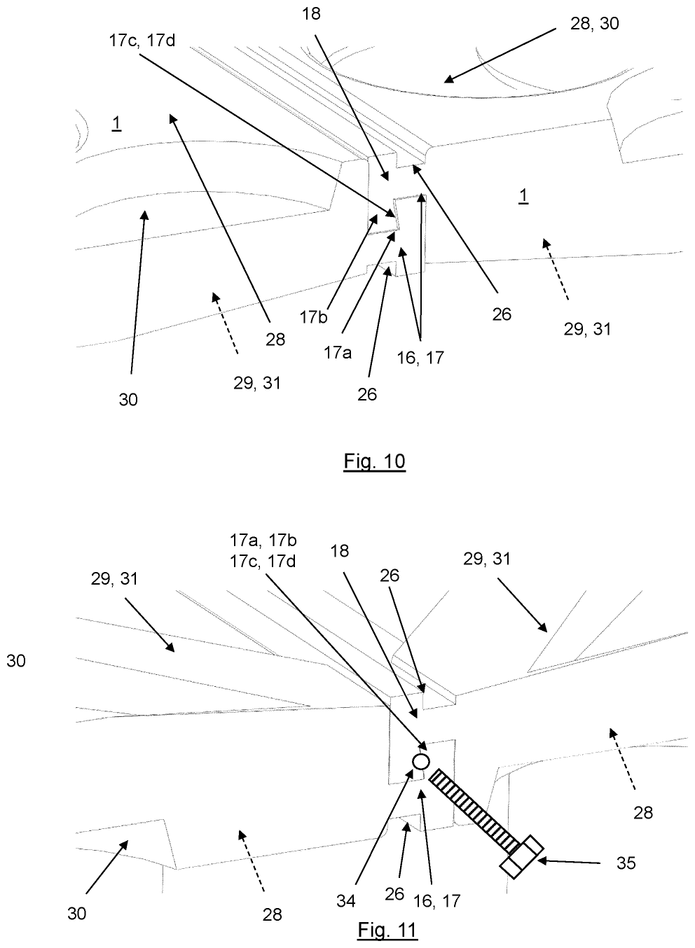

FIG. 10 schematically shows a close up of the sliding arrangement 16, 17 in FIGS. 8 and 9 according to one example. FIG. 10 shows that the sliding arrangement 16, 17 comprises a first sliding member 17a configured in one thermal structural element 9 and a second sliding member 17b configured in a second thermal structural element 9. The first and second sliding members 17a, 17b are configured with matching geometric features that allows for gripping into each other and holding the thermal structural elements 9 in place but at the same time allows for sliding. In FIG. 10, the sliding members 17a, 17b are configured with an essentially T-shaped sliding members with angled portions 17c, 17d that hinders other movement but sliding. The sliding members also comprises attachment means 26 along a side portion 22 for receiving a side wall 22 shown in FIGS. 8 and 9. The attachment means 26 can alternatively be used when stacking battery packs 6a on top of each other. In FIGS. 10 and 11 the sliding members 17a, 17b are arranged such that they are different on each side compared to the other side in order to safely match correct side of the battery packs to each other.

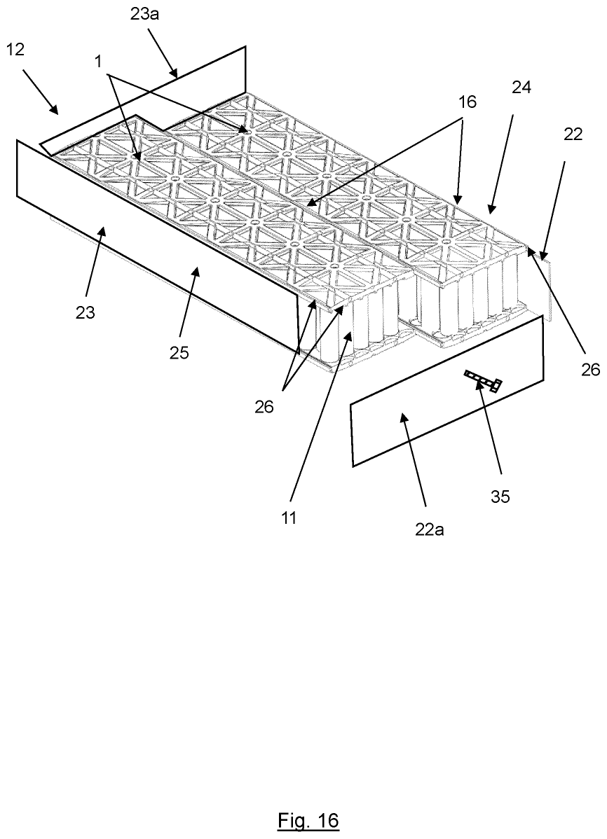

FIG. 11 schematically shows a close up of the sliding arrangement 16, 17 in FIGS. 8 and 9 according to one example. FIG. 11 is similar to FIG. 11 but where the sliding members 17a, 17b comprises a sliding member connection point 34 for securing the sliding members in place hindering further sliding. In FIG. 11, the connection point 34 is in the form of a channel like opening where a part of the channel is delimited by material in one sliding member 17a and the rest of the channel is delimited by the other sliding member 17b. FIG. 11 shows that an attachment means 35 is configured to be inserted in the connection point for securing the sliding members 17a, 17b. The attachment means 35 can be a bolt or a screw as shown in FIG. 11 or it may be an adhesive or any other suitable attachment means. Using a bolt or a screw 36 has the advantage that a side wall 22a, 22b, see FIG. 16, can be attached and secured to the battery arrangement 1.

The connecting means 16 in FIGS. 10 and 11 can hooking and snapping means 18 instead of sliding means 17. Hooking and snapping means 18 can look similar to what has been shown in FIGS. 10 and 11, but possibly without the angled portions 17c, 17d. Here, it is possible to pack two battery packs 6a together by angling one battery pack 6a with relation to a second battery pack 6a and hooking together the hooking means on the upper thermal structural elements 9 and then rotating the angled battery packs in a motion closing the gap between the two thermal structural elements 9 on the bottom until the hooking elements meet and snaps into place in a hooking arrangement. The use of an attachment means 35 and attachment means connection point 34 according to the above can be used also her, but can also be omitted if the thermal structural elements 9 are secured in place by other measures.

According to one example, see FIGS. 1-17, the thermal structural element 9 comprises a second through channel 19 extending along the top surface 7 and/or the bottom surface 8, wherein the first through channel 10 and the second through channel 19 extend from one side portion 11 of the thermal structural element 9 to an opposite side portion 12 of the thermal structural element 9, wherein the first and second through channels 10, 19 in the thermal structural element 9 are interconnected for inlet and outlet of cooling and/or heating medium from the same side portion.

According to one example, the side wall 22, 23 comprises fluid conductors 27 for connecting to the through channels 10, 19.

According to one example, not shown, the thermal structural element 9 comprises grooves and/or indentations 20 for housing connecting cables.

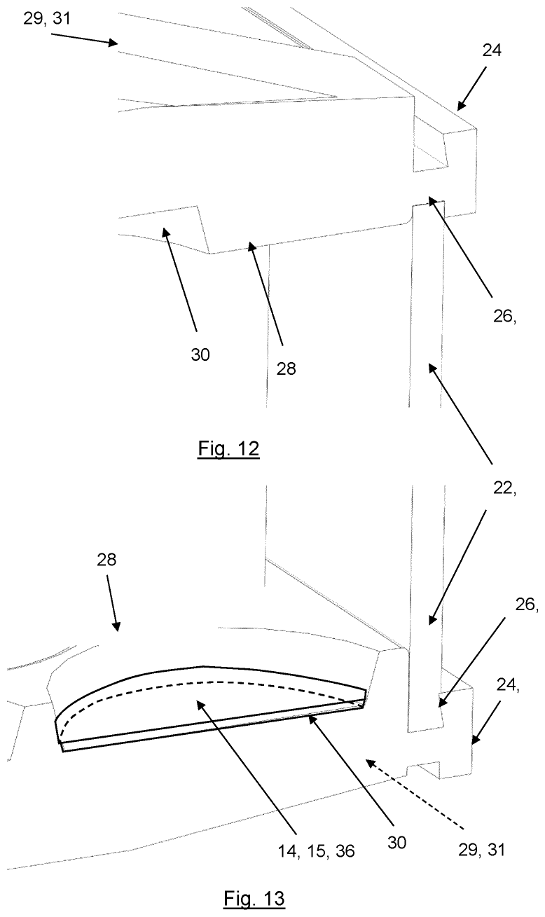

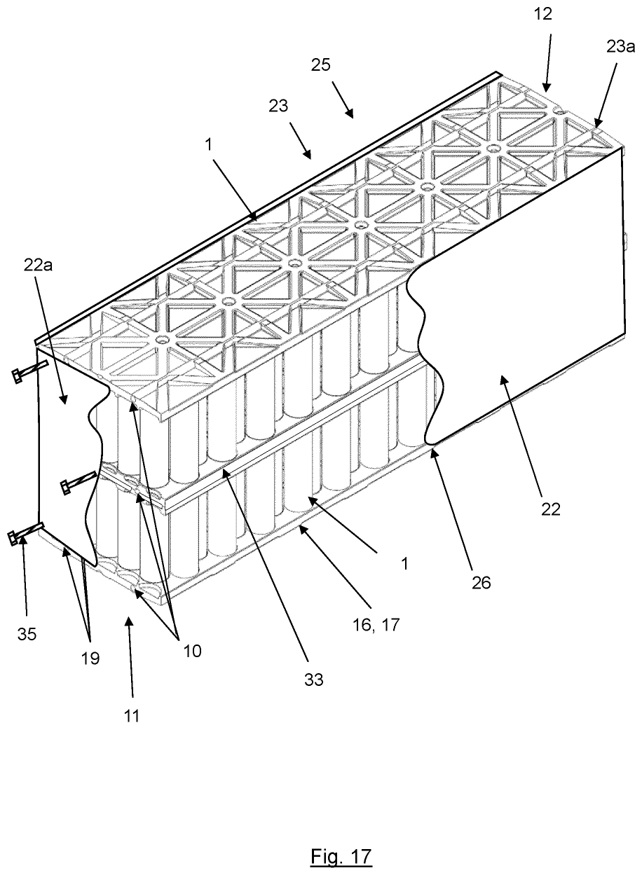

According to one example, see e.g. FIGS. 8, 9, 16 and 17, the arrangement 1 comprises at least one side wall 22, 23 attachable to at least one side portion 24, 25 of the thermal structural element 9, wherein the side wall 22 has an extension in the longitudinal direction as well as along the side portion 24, 25. According to one example, the thermal structural element 9 comprises attachment means 26 along at least one side portion 24, 25 for attachment of the sidewall 22, discussed above in connection to FIGS. 10 and 11. FIG. 16 schematically shows a similar view as FIG. 8 with four enclosing side walls 22, 23, 22a, 23a. FIG. 17 schematically shows a similar view as FIG. 4 with four enclosing side walls 22, 23, 22a, 23a. On or more of the side walls 22, 23, 22a, 23a can either be slid in place via attachment means 26 in the form of grooves as seen in FIGS. 10, 11, 12, 13 and/or can be attached with attachment means 26 in the form of adhesive, welding, bolting, pin rivet or any other suitable means. FIG. 12 schematically shows a close up of a side wall arrangement 22, 26 of an upper thermal structural element 9 in FIGS. 8 and 9 according to one example. FIG. 13 schematically shows a close up of a side wall arrangement 22, 26 of a bottom thermal structural element 9 in FIGS. 8 and 9 according to one example.

FIGS. 10, 11, 12 and 13 show that the side walls 22, 23, 22a, 23a can be arranged also between two battery packs 6a positioned side by side as in FIG. 8. One advantage here is that the side wall can be made from .e.g. a fire proof material that isolates the different battery packs 6a and thus hinders a fire from spreading. A further advantage is that such an intermediate side wall increases the stability and strength of the assembled battery arrangement 1.

With reference to the above:

FIG. 4 schematically shows a perspective view of two battery packs 6a positioned on top of each other in the height direction z according to one example. As can be seen in FIG. 17, the four side walls 22, 23, 22a, 23a can be arranged to cover both battery packs 6a. The below described packing of battery packs all have the possibility to have side walls 22, 23, 22a, 23a according to the above. However, regardless of the composition of the battery packs and how many battery packs 6a that are interconnected, the side walls 22, 23, 22a, 23a can be omitted on one or more sides. For example, if the device that is arranged to house the battery pack 6a is arranged with side walls, then one or more side walls 22, 23, 22a, 23a in the battery pack can be omitted. However, one advantage with using the side walls 22, 23, 22a, 23a connected to the thermal structural element 9 is that it increases the stability of the battery pack 6a and/or the battery unit and/or battery arrangement 1.

FIG. 5 schematically shows a perspective view of twelve battery packs 6a packed into one battery unit, wherein three battery packs 6a are positioned on top of each other in the height direction Z forming one sub unit, wherein two sub units are positioned next to each other in the length direction X and four sub units are positioned next to each other in the width direction Y forming the battery unit according to one example.

FIG. 6 schematically shows a perspective view of nine battery packs 6a packed into one battery unit, wherein three battery packs 6a are positioned on top of each other in the height direction Z forming one sub unit, wherein three sub units are positioned next to each other in the length X direction forming the battery unit according to one example.

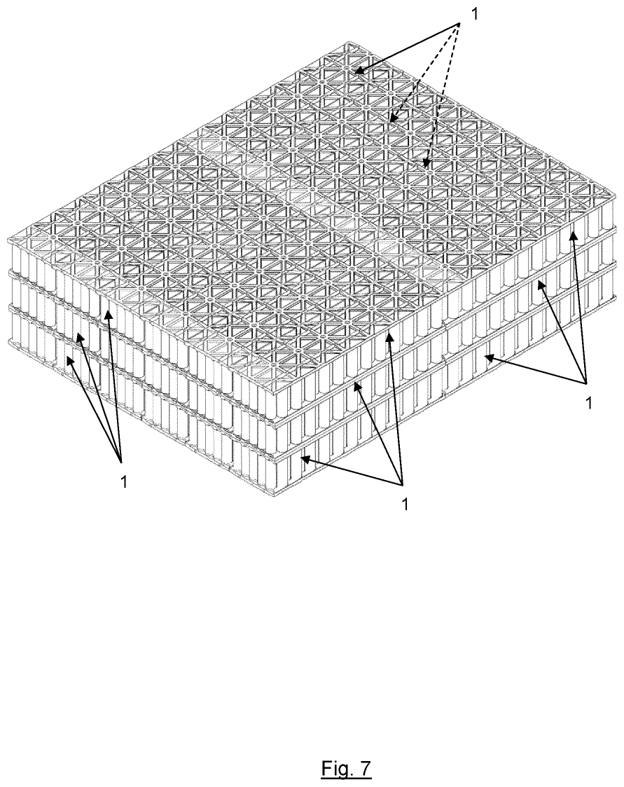

FIG. 7 schematically shows a perspective view of fifty-four battery packs 6a packed into one battery unit, wherein three battery packs 6a are positioned on top of each other in the height direction Z forming one sub unit, wherein two sub units are positioned next to each other in the length direction X and twelve sub units are positioned next to each other in the width Y direction forming the battery unit according to one example.

According to one example, see e.g. FIG. 20, the battery arrangement 1 is configured as a part of the structural body of a vehicle 38. Here, the battery arrangement 1 according to any one of the examples shown in any one of FIGS. 1-19 can be configured as a part of a vehicle 38 structural body and the structural elements 9 reinforce the structural body of the vehicle 38. However, the battery arrangement 1 according to any one of the examples shown in any one of FIGS. 1-19 can be part of any other structural body of an application in which the battery arrangement 1 is a part.

The Listing of claims replaces all previous versions of the claims:

1. A battery arrangement comprising: a number of batteries, each battery having a top end plate and a bottom end plate opposite the top end plate and a body connecting the top end plate and the bottom end plate, the body having an extension in a longitudinal direction between the top end plate and the bottom end plate and in a thickness direction being perpendicular to the longitudinal direction, wherein the body is delimited in the thickness direction by an envelope surface, wherein the batteries are arranged next to each other in the thickness direction forming a battery pack with a top surface and an opposing bottom surface in the longitudinal direction, wherein the top surface and the bottom surface have an extension in a width direction and a length direction being perpendicular to the longitudinal direction, wherein the battery arrangement comprises at least one thermal structural element arranged against the top surface and/or the bottom surface for cooling or heating the batteries via the top end plate and/or the bottom end plate, wherein the thermal structural element has an extension in the width direction and the length direction and a height coinciding with the longitudinal direction, wherein the thermal structural element is an extruded profile product comprising a surface pattern made from a rotating die in the extrusion process, said thermal structural element comprising a first through channel extending along the top surface and/or the bottom surface, wherein the first through channel extends from one side portion of the thermal structural element to an opposite side portion of the thermal structural element, the through channel being configured to lead a thermal fluid medium through the thermal structural element, wherein the battery arrangement comprises a fixation element configured to fixate the position of each battery with relation to the thermal structural element.

2. A battery arrangement according to claim 1, wherein the thermal structural element comprises structural features configured to withstand a predetermined force in at least the width direction and/or the length direction.

3. A battery arrangement according to claim 1, wherein the battery arrangement comprises a middle layer between the thermal structural element and the top surface and/or the bottom surface.

4. A battery arrangement according to claim 3, wherein the middle layer is arranged essentially over the entire top end plate and/or the bottom end plate and wherein the middle layer has a lower thermal conductivity than the thermal structural element and therefore acts as a thermal equalizer between the batteries and the thermal structural element.

5. A battery arrangement according to claim 3, wherein the middle layer comprises fixation elements in the form of attachment means for attaching the batteries to the thermal structural element.

6. A battery arrangement according to claim 3, wherein the middle layer is resilient allowing for a predetermined relative motion between the batteries and the thermal structural element.

7. A battery arrangement according to claim 1, wherein the thermal structural element comprises metal and wherein the battery arrangement comprises an electrically isolating middle layer between the thermal structural element and the top end plate and the bottom end plate.

8. A battery arrangement according to claim 6, wherein the thermal structural element is made from aluminium or an aluminium alloy.

9. A battery arrangement according to claim 1, wherein the thermal structural element is made from an electrically non-conductive material, wherein the thermal structural element is arranged directly against the top end plate and the bottom end plate or wherein the thermal structural element is made from an electrically non-conductive material, wherein the middle layer 4 is arranged between the thermal structural element and the top end plate and the bottom end plate.

10. A battery arrangement according to claim 3, wherein the middle layer is configured as a sheet material and/or a curable liquid.

11. A battery arrangement according to claim 1, wherein the battery arrangement comprises one thermal structural element arranged against the top surface and one thermal structural element arranged against the bottom surface for cooling or heating the batteries via the top end plate and/or the bottom end plate.

12. A battery arrangement according to claim 11, wherein the battery arrangement comprises at least one side wall attached to the two thermal structural element covering a side portion of the battery pack.

13. A battery arrangement according to claim 1, wherein the battery arrangement comprises at least two battery packs, wherein the thermal structural element from each battery pack is interconnected for forming an expanded battery arrangement wherein the thermal structural elements comprises connecting means along at least one of the side portions delimiting the thermal structural element in the width direction or the length direction for interconnecting the battery packs.

14. A battery arrangement according to claim 13, wherein the connecting means comprises sliding and connecting means allowing for interconnecting the thermal structural elements via a sliding operation or wherein the connecting means comprises hooking and connecting means allowing for interconnecting the thermal structural elements via a hooking operation.

15. A battery arrangement according to claim 1, wherein the battery arrangement comprises at least two battery packs stacked in the height direction, wherein the battery arrangement comprises an interconnecting thermal structural element with one side facing the batteries in one of the battery packs and a second side facing the batteries in the second battery pack, wherein both sides of the interconnecting thermal structural element have similar features as the side of the thermal structural elements that faces the batteries.

16. A battery arrangement according to claim 1, wherein the thermal structural element comprises a second through channel extending along the top surface and/or the bottom surface, wherein the first through channel and the second through channel extend from one side portion of the thermal structural element to an opposite side portion of the thermal structural element, wherein the first and second through channels in the thermal structural element are interconnected for inlet and outlet of the thermal fluid medium from the same side portion.

17. A battery arrangement according to claim 1, wherein the thermal structural element comprises grooves and/or indentations for housing connecting cables.

18. A battery arrangement according to claim 1, wherein the thermal structural element comprises at least one through opening extending in the height direction for receiving a fastening means extending through the through opening.

19. A battery arrangement according to claim 1, wherein the arrangement comprises at least one side wall attachable to at least one side portion of the thermal structural element, wherein the side wall has an extension in the longitudinal direction as well as along the side portion.

20. A battery arrangement according to claim 15, wherein the thermal structural element comprises attachment means along at least one side portion for attachment of the sidewall.

21. A battery arrangement according to claim 17, wherein the side wall comprises fluid conductors for connecting to the through channels.

22. A battery arrangement according to claim 1, wherein the thermal structural element comprises an underside facing the batteries and a topside facing away from the batteries, wherein the underside comprises the fixation elements configured to receive the top end plate and/or the bottom end plate.

23. A battery arrangement according to claim 20, wherein the topside comprises the structural features.

24. A battery arrangement according to claim 23, wherein the structural features comprises an isometric grid.

25. A battery arrangement according to claim 1, wherein the fixation element comprises an indentation and/or a middle layer and/or protrusions extending from the thermal structural element configured to secure the position of the battery.

26. A battery arrangement according to claim 1, wherein the structural thermal elements are made of metal with anodized surface providing thermal and/or electrical insulation between metal in structural thermal elements and the batteries.

27. A battery arrangement according to claim 1 utilizing the thermal structural elements as current collectors.

28. A battery arrangement according to claim 1, wherein the battery arrangement comprises temperature sensors attached to or in connection to the thermal structural elements.

29. A vehicle comprising a battery arrangement according to claim 1, wherein the battery arrangement is configured as a part of the structural body of a vehicle or any other structural body of an application in which the battery arrangement is a part.

30. A vehicle comprising a battery arrangement according to claim 1, wherein the battery arrangement is configured as a part of the structural body of a vehicle or any other structural body of an application in which the battery arrangement is a part.
